(19) United States
(12) Patent Application Publication
(10) Pub. No.: US 2004/0042201 A1
(43) Pub. Date: Mar. 4, 2004

(54) Liquid actuated lighting liquid container

(76) Inventor: Yih Yuh Lee, Shi Sha Town (TW)

Correspondence Address: Raymond Y. Chan, Suite 128, 108 N. Ynez Ave., Monterey Park, CA, 91754, US

(21) Appl. No.: 10/635,701

(22) Filed: Aug. 5, 2003

(30) Foreign Application Priority Data
Aug. 30, 2002 (TW) 91213629

(51) Int. Cl. F21V 33/00

(52) U.S. Cl. 362/101; 362/276; 362/802; 362/800

(57) ABSTRACT

A liquid actuated lighting liquid container, comprising a transparent cup body and a cup base. The bottom portion of the transparent cup body has two electrical terminals and the cup base extends from the bottom portion of the transparent cup body. The cup base comprises a circuit board, which further comprise a battery group, an illuminator, a low-level triggered circuit and a receiving socket. When a substantial amount of liquid is filled into the transparent cup body, a small current is conducted through the two electrical terminals, causing the low-level triggered circuit to produce a larger current, which in turn causes the lighting up of the illuminator.

### BACKGROUND OF THE PRESENT INVENTION

1. Field of Invention

The present invention relates to a liquid container, and more particularly to a liquid actuated lighting liquid container, wherein a liquid actuated lighting arrangement is actuated for providing a lighting effect when liquid is contained in the liquid container.

2. Description of Related Arts

Conventional containers for water or other drinks have uncountable models and shapes. Apart from the function of containing water or other drinks, liquid containers are mostly developed in the direction of new design in their appearances and shapes, or in the direction of thermal conservation. Designs of liquid containers are also affected by the targeted users, especially for young children.

As young children prefer new and interesting objects, designs of liquid containers for this targeted user group are mostly focused on cartoon characters incorporated with the appearance of the containers or in the form of toys, so as to attract attentions from children by those cute and lovely cartoon characters. However, due to the fact that visual effects caused by such designs are simple static visual effects, the effectiveness of attracting attentions of young children by utilizing new and interesting designs is limited.

Alternatively, another type of container is incorporated with a dynamic display. Such container essentially comprises of an outer layer and an inner layer of transparent materials, wherein a sealed receiving cavity is defined between the two layers of transparent materials and the sealed receiving cavity is filled with liquid, wherein the liquid is mixed with a variety of geometrical objects or toy designs. However, in order to avoid the problem of having a container with very thick and heavy walls, the distance between the two layers of transparent materials cannot be too wide, which in turns causes the geometrical objects or the toy designs mixed with the liquid to be mostly flat or two-dimensional. As the geometrical objects or the toy designs can be heavier, lighter or even having the same weight as the liquid, the objects or designs mixed with the liquid can float up or down in the liquid when the container is turned over or shook, causing dynamic visual effects. However, since these weight-related dynamic visual effects are caused by the weight difference between the geometrical objects or toy designs and the liquid, and since, in order for the objects or design to float upwards or sink downwards slowly, an appropriate amount of resistance force between the liquid and the objects or design must be present. And usually, the container must be turned up-side down in order to obtain the dynamic visual effects. As a result, when the container is filled with water or other drinks, the dynamic visual effects can hardly be displayed.

Furthermore, dynamic displays of such containers are merely objects floating upwards or sinking downwards inside a liquid, its effectiveness in arousing the interest and attracting the attention of young children is limited.

### SUMMARY OF THE PRESENT INVENTION

A main object of the present invention is to provide a liquid actuated lighting liquid container, wherein a liquid actuated lighting arrangement is actuated for providing a lighting effect when liquid is contained in the liquid container.

Another object of the present invention is to provide a liquid actuated lighting liquid container, wherein two terminals are sealingly mounted to the cup body in a watertight manner so as to prevent the leakage of the liquid within the cup body.

Another object of the present invention is to provide a liquid actuated lighting liquid container, wherein the cup base is integrally extended from the cup body to form a one-piece member to avoid the liquid leaking from the cup body to the cup base so as to prevent the circuit from being damaged within the cup base.

Another object of the present invention is to provide a liquid actuated lighting liquid container, wherein no expensive or complicated electrical and mechanical structure is employed in the present invention, so as to minimize the manufacturing cost of the liquid container incorporating with the liquid actuated lighting arrangement having two terminals.

Accordingly, in order to accomplish the above objects, the present invention provides a liquid container, comprising:

a transparent cup body having a liquid cavity defined therewithin, wherein a bottom portion of the transparent cup body has two electrical terminals, wherein the two electrical terminals are electrically conducted when the liquid cavity is filled with a substantial amount of liquid; and

a cup base, extending from the bottom portion of the transparent cup body, wherein the cup base comprises a circuit board, wherein the circuit board further comprises a battery group, an illuminator, a low-level triggered circuit and a receiving socket, wherein the bottom portion of the transparent cup body is connected to the receiving socket of the cup base.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a liquid actuated lighting liquid container according to a preferred embodiment of the present invention.

FIG. 2 is an exploded perspective view of the liquid actuated lighting liquid container according to the above preferred embodiment of the present invention.

FIG. 3 is a sectional view of the liquid actuated lighting liquid container according to the above preferred embodiment of the present invention.

FIG. 4 illustrates an alternative mode of the liquid actuated lighting liquid container according to the above preferred embodiment of the present invention.

### DETAILED DESCRIPTION OF THE PREFERRED EMBODIMENT

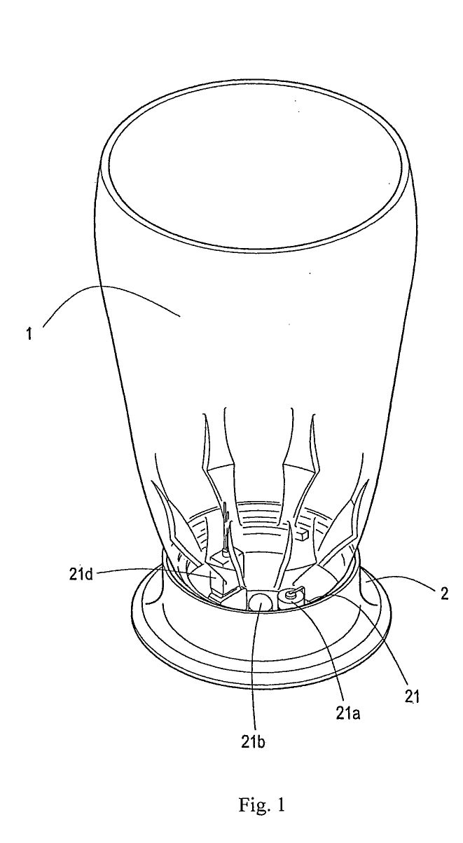

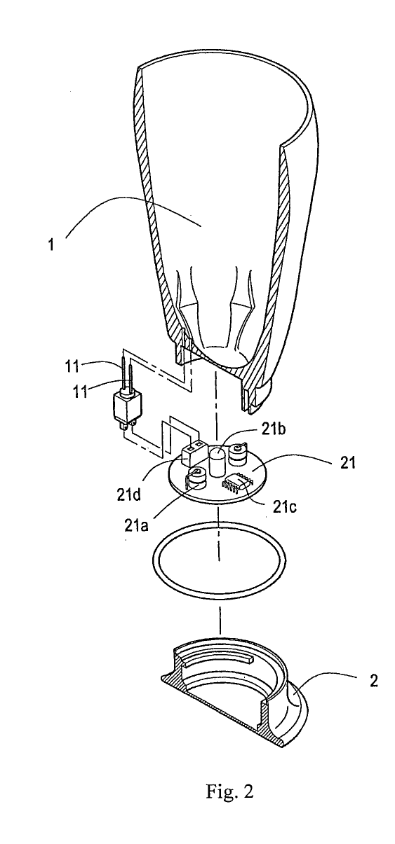

Referring to FIG. 1 and FIG. 2 of the drawings, a liquid actuated lighting liquid container comprises a transparent cup body 1 and a cup base 2.

The transparent cup body 1, wherein two electrical terminals 11 are located penetrably at a bottom portion of the cup body 1.

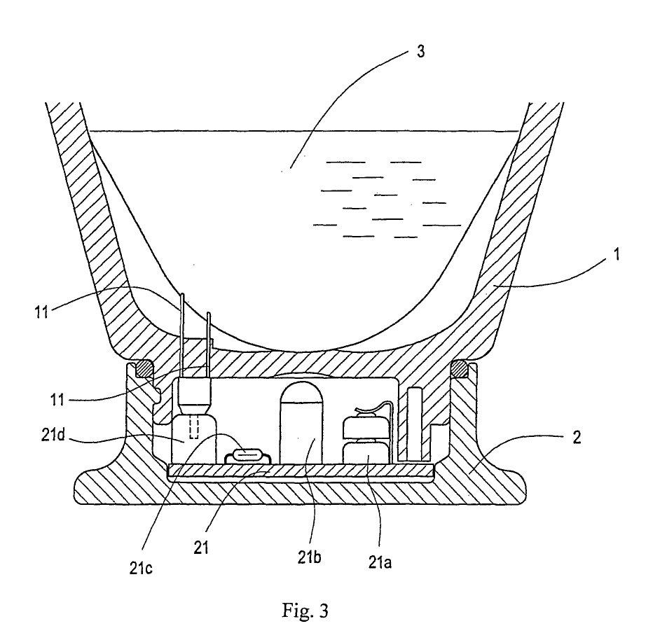

Referring to FIG. 3 of the drawings, the cup base 2, attached to the bottom portion of the cup body 1, wherein said cup base 2 has a circuit board 21, wherein on top of the circuit board 21 are a battery group 21a, an illuminator 21b, a low-level triggered circuit 21c and a receiving socket 21d, wherein the end portion of the electrical terminals 11 of the bottom portion of the cup body 1 is connected to the receiving socket 21d of the circuit board 21.

According to the above preferred embodiment of the present invention, when a liquid 3 is filled into the transparent cup body 1, the liquid 3 acts as a conducting media, causing a small current to flow through two electrical terminals 11, so that electrical energy is conducted between the two electrical terminals 11, and will not cause electrolysis, which in turn causes a current to flow through the low-level triggered circuit 21c on the circuit board 21, providing a larger current of electrical energy for the illuminator 21b to light up, displaying an unexpected visual effect.

Furthermore, when transparent cup body 1 is filled with the liquid 3 and electrically conducting the two electrical terminals 11, causing the lighting up of the illuminator 21b, the refraction of the light emitted by the illuminator 21b caused by the liquid 3 provides variations to the lighting effect. Also, if the liquid 3 is colored, as an example, brown colored coke or purple colored grape juice, the light emitted by the illuminator will be enhanced, thereby creating even more lighting effects.

The illuminator 21b is a tri-colored LED having two diodes or a plurality of different-colored LED having two diodes to enhance the lighting effect by electrifying the diodes. In other words, the illuminator 21b is capable of producing different colors when diodes are electrified respectively.

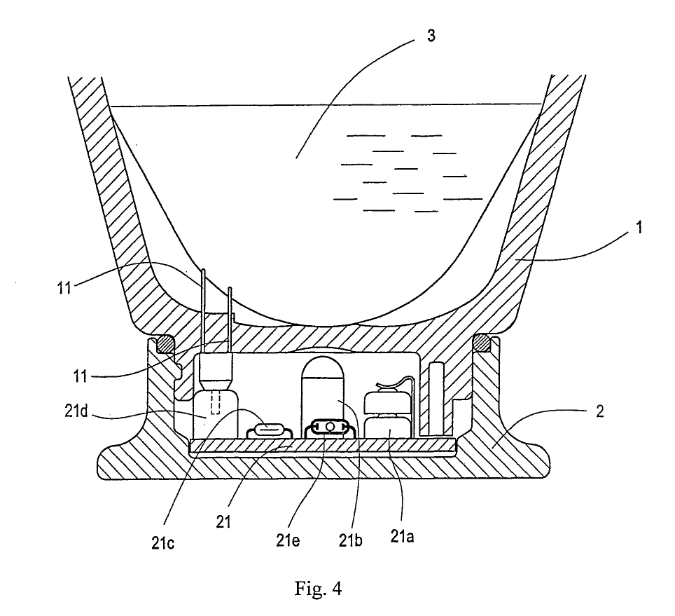

Referring to FIG. 4 of the drawings, in an alternative mode of the preferred embodiment of the present invention, the circuit board 21 further comprises a motion sensing switch 21d, which detects motion of the transparent cup body 1. When motion is detected, the motion sensing switch 21d produces an electrical current to the low-level triggered circuit 21c, which in turns causes the illuminator 21b to light up.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A liquid actuated lighting liquid container, comprising:
a transparent cup body having a liquid cavity defined therewithin, wherein a bottom portion of said transparent cup body has two electrical terminals, wherein said electrical terminals are electrically conducted when said liquid cavity is filled with a substantial amount of liquid; and
a cup base, extending from said bottom portion of said transparent cup body, wherein said cup base has a circuit board, wherein said circuit board further comprises a battery group, an illuminator, a low-level triggered circuit and a receiving socket, wherein said bottom portion of said transparent cup body is connected to said receiving socket of said cup base.

2. A liquid actuated lighting liquid container, as recited in claim 1, wherein said illuminator is a tricolored LED having two diodes.

3. A liquid actuated lighting liquid container, as recited in claim 1, wherein said illuminator is a plurality of different-colored LED having two diodes.

4. A liquid actuated lighting liquid container, as recited in claim 1, wherein said circuit board further comprises a motion sensing switch.
